(19) United States
(12) Patent Application Publication
(10) Pub. No.: US 2026/0162226 A1
(43) Pub. Date: Jun. 11, 2026

(54) MULTI-MOTION GENERATION

(71) Applicant: Honda Motor Co., Ltd., Tokyo (JP)

(72) Inventors: Seunggeun CHI, West Lafayette, IN (US); Hyung-gun CHI, Campbell, CA (US); Faizan SIDDIQUI, Santa Clara, CA (US); Nakul AGARWAL, San Francisco, CA (US); Hengbo MA, Mountain View, CA (US); Kwonjoon LEE, San Jose, CA (US)

(21) Appl. No.: 18/969,675

(22) Filed: Dec. 5, 2024

(51) Int. Cl. G06T 5/60; G06T 5/70; G06T 13/00

(52) U.S. Cl. CPC G06T 5/60; G06T 5/70; G06T 13/00; G06T 2207/20081; G06T 2207/20084

(57) ABSTRACT

According to one aspect, a multi-motion generation may include training a variational autoencoder (VAE) model based on a skeletal representation of human motion, one or more motion tokens associated with the skeletal representation of the human motion, and a dynamic transition probability based on a distance between the one or more motion tokens and training a denoise transformer by performing self-attention based on the one or more motion tokens and cross-attention based on the one or more motion tokens and an action sentence.

### BACKGROUND

The generation of human motion is a rapidly advancing field with profound applications in areas such as animation, virtual reality (VR), augmented reality (AR), and human-computer interaction. Particularly, the ability to accurately convert textual descriptions into realistic, fluid human motions is not just a remarkable technical achievement but also a useful step towards more immersive digital experiences. Recent progress in human motion generation has seen a surge in the use of deep learning models. These advancements have been useful in aligning textual descriptions with corresponding human motions. However, generating such sequences presents unique challenges where models often struggle to maintain continuity and coherence throughout a series of actions.

### BRIEF DESCRIPTION

According to one aspect, a computer-implemented method for multi-motion generation may include training a variational autoencoder (VAE) model based on a skeletal representation of human motion, one or more motion tokens associated with the skeletal representation of the human motion, and a dynamic transition probability based on a distance between the one or more motion tokens and training a denoise transformer by performing self-attention based on the one or more motion tokens and cross-attention based on the one or more motion tokens and an action sentence.

According to one aspect, a system for multi-motion generation may include a processor and a memory. The memory may store one or more instructions and the processor may execute one or more of the instructions stored on the memory to perform one or more acts, actions, or steps, such as receiving a runtime action sentence, converting the runtime action sentence into a set of runtime motion tokens, iteratively unmasking runtime motion tokens of the set of runtime motion tokens using a trained denoise transformer, and transforming the unmasked runtime motion tokens into a runtime skeletal representation of the human motion using a trained variational autoencoder (VAE) model. The trained VAE model may be trained based on a skeletal representation of human motion, one or more motion tokens associated with the skeletal representation of the human motion, and a dynamic transition probability based on a distance between the one or more motion tokens. The trained denoise transformer may be trained by performing self-attention based on the one or more motion tokens and cross-attention based on the one or more motion tokens and an action sentence.

According to one aspect, a system for multi-motion generation may include a processor and a memory. The memory may store one or more instructions and the processor may execute one or more of the instructions stored on the memory to perform one or more acts, actions, or steps, such as receiving a runtime action sentence, converting the runtime action sentence into a set of runtime motion tokens, iteratively unmasking runtime motion tokens of the set of runtime motion tokens using a trained denoise transformer, and transforming the unmasked runtime motion tokens into a runtime skeletal representation of the human motion using a trained vector quantized variational autoencoder (VQ-VAE) model. The trained VQ-VAE model may be trained based on a skeletal representation of human motion, one or more motion tokens associated with the skeletal representation of the human motion, and a dynamic transition probability based on a distance between the one or more motion tokens. The trained denoise transformer may be trained by performing self-attention based on the one or more motion tokens and cross-attention based on the one or more motion tokens and an action sentence.

### BRIEF DESCRIPTION OF THE DRAWINGS

FIG. 1 is an exemplary flow diagram of a computer-implemented method for multi-motion generation, according to one aspect.

FIG. 2 is an exemplary component diagram of a system for multi-motion generation, according to one aspect.

FIG. 3 is an exemplary vector quantized variational autoencoder (VQ-VAE) in association with the system for multi-motion generation, according to one aspect.

FIG. 4A is an exemplary denoise transformer in association with the system for multi-motion generation, according to one aspect.

FIG. 4B is an exemplary multi-motion discrete diffusion model in association with the system for multi-motion generation, according to one aspect.

FIG. 5 is an exemplary vector quantized variational autoencoder (VQ-VAE) decoder in association with the system for multi-motion generation, according to one aspect.

FIG. 6 is an exemplary vector quantized variational autoencoder (VQ-VAE) decoder with two-phase sampling (TPS) in association with the system for multi-motion generation, according to one aspect.

FIG. 7 is an exemplary algorithm in association with the system for multi-motion generation, according to one aspect.

FIG. 8 is an illustration of an example computing environment where one or more of the provisions set forth herein are implemented, according to one aspect.

FIG. 9 is an illustration of an example computer-readable medium or computer-readable device including processor-executable instructions configured to embody one or more of the provisions set forth herein, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

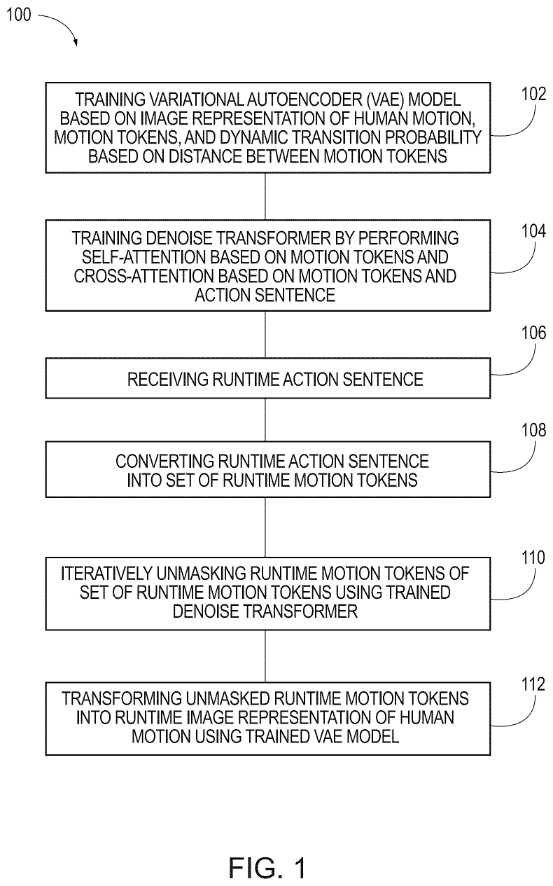

FIG. 1 is an exemplary flow diagram of a computer-implemented method 100 for multi-motion generation, according to one aspect. For example, the computer-implemented method 100 for multi-motion generation may include training 102 a variational autoencoder (VAE) model based on a skeletal representation of human motion (e.g., joint representation), one or more motion tokens associated with the skeletal representation of the human motion, and a dynamic transition probability based on a distance between the one or more motion tokens, training 104 a denoise transformer by performing self-attention based on the one or more motion tokens and cross-attention based on the one or more motion tokens and an action sentence, receiving 106 a runtime action sentence, converting 108 the runtime action sentence into a set of runtime motion tokens, iteratively unmasking 110 runtime motion tokens of the set of runtime motion tokens using the trained denoise transformer, and transforming 112 the unmasked runtime motion tokens into a runtime skeletal representation of the human motion using the trained VAE model.

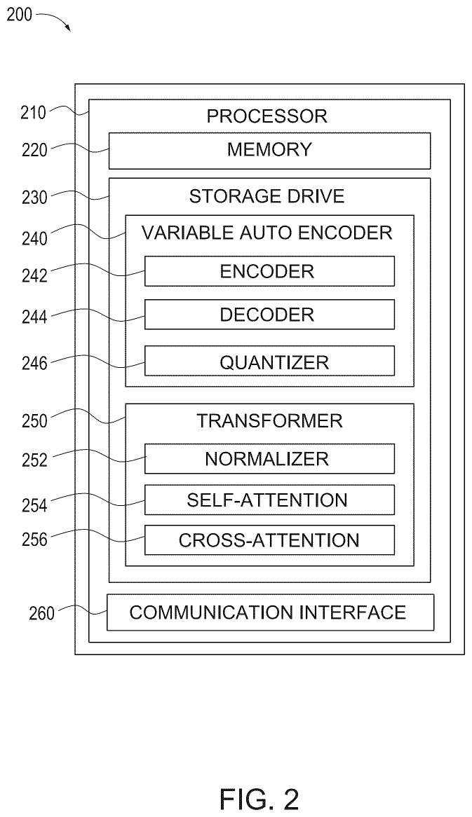

FIG. 2 is an exemplary component diagram of a system 200 for multi-motion generation, according to one aspect. The system 200 for multi-motion generation may include a processor 210, a memory 220, a storage drive 230, and a communication interface 260, which may receive one or more elements to be stored on the storage drive 230. The storage drive 230 may store a variational autoencoder (VAE) model 240 and a denoise transformer 250. The VAE model 240 may include an encoder 242, a decoder 244, and a quantizer 246, and may include a convolutional neural network (CNN) architecture which may employ 1-dimensional (1D) convolutions. The VAE model 240 may be a vector quantized variational autoencoder (VQ-VAE) model. The denoise transformer 250 may include a normalizer 252, a self-attention mechanism 254, and a cross-attention mechanism 256. In this way, a multi-motion discrete diffusion model (M2D2M) may be provided to facilitate multi-motion generation and include the VAE model 240 and the denoise transformer 250. For example, the M2D2M enables human motion generation from text action descriptions based on discrete diffusion models.

### Discrete Diffusion Models

Diffusion models are generally defined by forward Markov processes and reverse Markov processes. Diffusion models transform data into increasingly noisy variables and subsequently denoising them, benefit from stability and rapid sampling capabilities. Enhanced by neural networks learning the reverse process, diffusion models are particularly effective in continuous spaces like images. Latent diffusion models, operating in a latent space before returning to the original data space, adeptly handle complex data distributions.

In discrete spaces such as with text, diffusion models also perform well. D3PM and vector quantized (VQ) diffusion models have shown that structured categorical corruption and mask-and-replace to minimize errors in iterative models. In this way, discrete diffusion models may be applied in the context of human motion generation from text.

Discrete diffusion models are a class of diffusion models that work by gradually adding noise to data and learning to reverse this process by denoising. Unlike continuous models, such as latent diffusion models, which operate on data represented in a continuous space, discrete diffusion models work with data representation in discrete state spaces.

### Discrete Diffusion Models—Forward Diffusion Process

VQ-diffusion models incorporate a mask-and-replace strategy. VQ-diffusion includes a forward diffusion process by transitioning from one token to another token or to a special mask token. A transition probability from token zᵢ to zⱼ at diffusion step t is determined by Qₜ[i, j]. A transition matrix, Qₜ∈ [symbol] ^{(K+1)×(K+1)}, may be structured as:

$${Q}_{t} = [ \begin{matrix}{α}_{t} + {β}_{t} & {β}_{t} & … & {β}_{t} & 0 \\ {β}_{t} & {α}_{t} + {β}_{t} & … & {β}_{t} & 0 \\ ⋮ & ⋮ & ⋱ & ⋮ & ⋮ \\ {β}_{t} & {β}_{t} & … & {α}_{t} + {β}_{t} & 0 \\ {γ}_{t} & {γ}_{t} & … & {γ}_{t} & 1\end{matrix} ] \qquad ( 1 )$$

where βₜ represents the probability of transitioning between the different tokens, γₜ denotes the probability of transitioning to a mask token, αₜ=1−Kβₜ−γₜ, and the token transition probability from diffusion steps t to t−1 is given by:

$$q ( {z}_{t} \vert {z}_{t - 1} ) = {v}^{T} ( {z}_{t} ) {Q}_{t} v ( {z}_{t - 1} ) \qquad ( 2 )$$

where v(zₜ)∈ [symbol] ^{(K+1)×1} denotes a one-hot encoded vector for a token index of zₜ. Due to the Markov property, the probabilities of zₜ at an arbitrary diffusion time step may be derived q(zₜ|z₀)=v^{T}(zₜ)Q̅ₜv(z₀), where Q̅ₜ=QₜQₜ₋₁ . . . Q₁. The transition matrix may be constructed such that the mask token always maintains its original state so that zₜ converges to a mask token with sufficiently large t.

### Discrete Diffusion Models—Conditional Reverse Denoising Process

The conditional reverse denoising process may be performed through a neural network p_{θ}. The neural network may predict the noiseless token z₀ when provided with a corrupted token and its corresponding condition, such as a language token. The tractable posterior distribution of discrete diffusion may be expressed as:

$$q ( {z}_{t - 1} \vert {z}_{t} , {z}_{0} ) = \frac{q ( {z}_{t} \vert {z}_{t - 1} , {z}_{0} ) q ( {z}_{t - 1} \vert {z}_{0} )}{q ( {z}_{t} \vert {z}_{0} )} = \frac{( {v}^{T} ( {z}_{t} ) {Q}_{t} v ( {z}_{t - 1} ) ) ( {v}^{T} ( {z}_{t - 1} ) {\overline{Q}}_{t - 1} v ( {z}_{0} ) )}{{v}^{T} ( {z}_{t} ) {\overline{Q}}_{t} v ( {z}_{0} )} \qquad ( 3 )$$

The reverse transition distribution may be determined as follows:

$${p}_{θ} ( {z}_{t - 1} \vert {z}_{t} , y ) = {\sum }_{{\tilde{z}}_{0} = 1}^{K} q ( {z}_{t - 1} \vert {z}_{t} , {\tilde{z}}_{0} ) {p}_{θ} ( {\tilde{z}}_{0} \vert {z}_{t} , y ) \qquad ( 4 )$$

The processor 210 may iteratively denoise tokens from T down to 1 to obtain the generated token z₀ conditioned on y.

For training the neural network p_{θ}, beyond the denoising objective, the training approach may also incorporate a standard variational lower bound objective, denoted as [symbol] _{vlb}. In this regard, an overall training objective may be expressed as:

$$ℒ = {ℒ}_{vlb} + λ {{z}_{t} ∼ q ( {z}_{t} \vert {z}_{0} )}_{} [ - log {p}_{θ} ( {z}_{0} \vert {z}_{t} , y ) ] \qquad ( 5 )$$

where λ denotes a coefficient for a denoising loss.

### Multi-Motion Discrete Diffusion Model (M2D2M)

M2D2M is a type of discrete diffusion model designed for generating human motion from textual descriptions, with a focus on handling long-term motion sequences. A discrete codebook space, based on VQ-VAE, may be utilized in representing human motion. Advantages and benefits provided by the M2D2M include a dynamic transition probability within the discrete diffusion model, which adapts transition probabilities based on the proximity between motion tokens, facilitating nuanced and context-sensitive human motion generation.

### Training Phase—VQ-VAE

To establish a codebook for discrete diffusion, the processor 210 may train a VQ-VAE model 240. The VQ-VAE model 240 may include an encoder E(⋅) (e.g., the encoder 242), a decoder D(⋅) (e.g., the decoder 244), and a quantizer Q(⋅) (e.g., the quantizer 246). The encoder 242 E(⋅) processes human motion, represented by x∈ [symbol] ^{L×D}, converting it into motion tokens,

$$z = E ( x ) ∈ {\frac{L}{4} \times D}^{} .$$

Here, L signifies the length of the motion sequence. Subsequently, the decoder 244 utilizes these motion tokens to reconstruct the human motion as \hat{x}=D(z). The quantizer 246 maps the motion token at any timeframe t to the nearest codebook entry, determined by Z_{q}[τ]=Q(z[τ])=argmin_{c}_{ᵢ}_{∈c}∥z[τ]−cᵢ∥₂. Here, C={c₁, . . . , c_{K}} represents the codebook, where K signifies a total number of codebooks and D denotes a dimensionality of each codebook. The processor 210 may train the motion VQ-VAE according to the following loss function:

$${ℒ}_{VQ} = {‖ x - \hat{x} ‖}_{2} + {‖ {z}_{q} - sg [ z ] ‖}_{2} + {λ}_{VQ} {‖ sq [ {z}_{q} ] - z ‖}_{2} \qquad ( 6 )$$

where sg[⋅] represents stop gradient and λ_{VQ} is coefficient for commitment loss.

In this way, the processor 210 may train the VQ-VAE model 240 based on a skeletal representation of human motion, one or more motion tokens associated with the skeletal representation of the human motion, and a dynamic transition probability based on a distance between the one or more motion tokens.

### Training Phase—Dynamic Transition Probability

In the VQ-diffusion model, the transition matrix Qₜ utilizes a uniform transition probability βₜ across different tokens, as described in Equation (1). To account for varying proximity between motion tokens, which may be useful in capturing the context of human motion, a dynamic transition probability that accounts for the distance between tokens is provided herein. During initial stages of diffusion, when the diffusion step t is large, the dynamic transition probability model adopts an exploratory approach, allowing for a wide range of transitions to foster diversity. As t progresses to 0, the dynamic transition probability model gradually shifts to favor transitions between more distantly related tokens. This transition from a broad to a more focused approach enables the dynamic transition probability model to more accurately reconstruct or generate sequences that adhere to the intricate patterns of human motion. In this way, the dynamic transition probability described herein commences with a broad exploration and progressively narrows the focus as diffusion steps decrease, thereby improving the precision and coherence in generating extended motion sequences.

The transition probability at each diffusion step t may be formulated as β(t, d), where d signifies the distance between codebook tokens. The transition probability may be defined as follows:

$$β ( t , d ) = ( 1 - {γ}_{t} - {α}_{t} ) \cdot soft {max}_{d} ( η \cdot \frac{t}{T} \cdot \frac{d}{K} ) \qquad ( 7 )$$

where η is a scale factor that modulates an influence of the softmax function on the relative distances between tokens.

The softmax function of Equation (7) progressively assigns higher probabilities to greater distances between tokens as the diffusion step t advances. This allocation adheres to the transition probability constraint

$${γ}_{t} + {α}_{t} + {\sum }_{d = 1}^{K} β ( t , d ) = 1.$$

The distance-based modulation, scaled by

$$η \cdot \frac{t}{T} \cdot \frac{d}{K} ,$$

ensures that as the diffusion process unfolds, the selection of token transitions becomes increasingly governed by the distance metric d. In this way, the structural integrity of the original motion sequence may be preserved. The transition matrix Qₜ may be structured as follows:

$${Q}_{t} = [ \begin{matrix}{α}_{t} + β ( t , {d}_{1 , 1} ) & β ( t , {d}_{1 , 2} ) & … & β ( t , {d}_{1 , K} ) & 0 \\ β ( t , {d}_{2 , 1} ) & {α}_{t} + β ( t , {d}_{2 , 2} ) & … & β ( t , {d}_{2 , K} ) & 0 \\ ⋮ & ⋮ & ⋱ & ⋮ & ⋮ \\ β ( t , {d}_{K , 1} ) & β ( t , {d}_{K , 2} ) & … & {α}_{t} + β ( t , {d}_{K , K} ) & 0 \\ {γ}_{t} & {γ}_{t} & … & {γ}_{t} & 1\end{matrix} ] \qquad ( 8 )$$

In this matrix, d_{i,j}=d(zᵢ, zⱼ), and d(⋅,⋅) is the distance metric, specifically chosen as the rank index of codebook entries sorted by their L2 distances. This selection is based on a comparative analysis of various distance functions. The dynamic and context-sensitive nature of this matrix formulation allows for an adaptive approach to the diffusion process, modifying transition probabilities in response to the evolving state of the diffusion and the relative distances between motion tokens.

In this way, the M2D2M leverages structured capabilities of discrete diffusion models and utilizes the dynamic transition probability mechanism to consider a proximity (e.g., distance) between the one or more motion tokens within the discrete diffusion framework. One benefit or advantage to the dynamic transition probability mechanism is that it enables generation of complex, coherent motion sequences with high fidelity accurately. The dynamic transition probability mechanism adjusts the transition probabilities based on exploration and exploitation principles. Initially, the dynamic transition probability mechanism allows for broad exploration of diverse motions by selecting distant elements from a codebook in early diffusion stages. As the process progresses, the dynamic transition probability mechanism shifts focus towards selecting closer elements, refining the probabilities for improved accuracy in generating single motions, embodying the principle of exploitation.

Further, M2D2M employs an advanced smoothing process in the denoising stage of diffusion, ensuring a fluid and continuous motion, thereby bridging the gap in multi-motion generation, offering a sophisticated solution for creating realistic, multi-motion from textual descriptions. The VQ-VAE model 240 may convert the skeletal representation of the human motion into one or more motion tokens (e.g., having a numerical representation) and reconstruct the human motion (e.g., skeletal representation) from the one or more motion tokens (e.g., the numerical representation).

### Training Phase—Denoise Transformer

The processor 210 may train the denoise transformer 250 by performing self-attention (e.g., via self-attention mechanism 254) based on the one or more motion tokens and cross-attention (e.g., via cross-attention mechanism 256) based on the one or more motion tokens and an action sentence. The action sentence may include text, such as one or more phrases, words, nouns, verbs, etc. The self-attention of the one or more motion tokens may involve each frame attending to itself. Training the denoise transformer 250 may include performing normalization on the one or more motion tokens. Performing the self-attention may be based on relative positional encoding (RPE). Training the denoise transformer 250 may include performing the cross-attention based an action token derived from the action sentence. The cross-attention may enable a mapping of a correspondence between text of the action sentence and the numerical representation of the one or more motion tokens. The denoise transformer 250 may include one or more layers, one or more attention heads, one or more embedding dimensions, one or more hidden dimensions, etc.

The denoising transformer estimates the distribution p_{θ}(\tilde{z}₀|zₜ, y). To incorporate the diffusion step t into the network, adaptive layer normalization (AdaLN) may be implemented (e.g., via normalizer 252). The action sentence a may be encoded into the action token y using a text encoder, such as the CLIP encoder, for example. The denoising transformer's cross-attention mechanism may integrate this action information with motion, providing a nuanced conditioning with the action sentence. To enhance human motion generation of the denoising transformer architecture, additional features such as relative positional encoding (RPE) and classifier free guidance may be implemented.

### Relative Positional Encoding

One objective may be the generation of long-term motion sequences. During the training phase, models exclusively trained on single-motions often struggle to generate longer sequences. However, by utilizing Relative Positional Encoding (RPE), the M2D2M model may be equipped with the ability to extrapolate beyond the sequence lengths experienced during the training phase, thereby significantly enhancing their proficiency in generating extended motion sequences.

### Classifier-Free Guidance

Classifier-free guidance facilitates a balance between diversity and fidelity, allowing both conditional and unconditional sampling from the same model. For unconditional sampling, a learnable null token, denoted as Ø, may be substituted for the action token y. The action token y may be replaced by Ø with a probability of 10%, for example. During inference, the denoising step is defined using s as follows:

$$log {p}_{θ} ( {z}_{t - 1} \vert {z}_{t} , y ) = ( s + 1 ) log {p}_{θ} ( {z}_{t - 1} \vert {z}_{t} , y ) - s log {p}_{θ} ( {z}_{t - 1} \vert {z}_{t} , ∅ ) \qquad ( 9 )$$

### Runtime Phase

At runtime, or during an execution phase, the processor 210 may receive a runtime action sentence (e.g., including text, such as one or more phrases, words, nouns, verbs, etc.), convert the runtime action sentence into a set of runtime motion tokens, iteratively unmask runtime motion tokens of the set of runtime motion tokens using the trained denoise transformer 250, and transform the unmasked runtime motion tokens into a runtime skeletal representation of the human motion using the trained VQ-VAE model 240. Thus, an action sentence functions as a condition. The denoise transformer 250 denoises (e.g., unmasks) “masked motion tokens”, ultimately producing unmasked motion tokens. An action sentence serves as a condition; “masked motion tokens” are denoised into unmasked motion tokens based on the action sentences. The processor 210 may, for example, iteratively unmask runtime motion tokens of the set of runtime motion tokens using the trained denoise transformer 250 until no frames are masked. Additionally, the conditioning is done through the cross-attention mechanism 256.

### Two Phase Sampling (TPS) for Multi-Motion Generation

Two-phase sampling (TPS) may include independent denoising and joint denoising to create the discrete diffusion model designed to generate long-term human motion sequences from a series of action descriptions a=a¹, . . . , a^{N}. TPS enables the processor 210 to generate multi-motion using models trained on single-motion generation without requiring any additional training for multi-motion generation, which is particularly advantageous given the scarcity of datasets containing multiple actions. In this way, TPS enables M2D2M to effectively generate long-term, smooth, and contextually coherent human motion sequences, utilizing a model trained for single-motion generation. For example, TPS enhances the natural flow of the motion, ensuring that transitions between actions are both smooth and realistic.

The processor 210 may, for example, receive an action sentence including a first action and a second action, convert the action sentence into a first set of motion tokens corresponding to the first action and a second set of motion tokens corresponding to the second action, iteratively unmask motion tokens of the first set of motion tokens using the trained denoise transformer 250 to generate a first set of unmasked motion tokens, iteratively unmask motion tokens of the second set of motion tokens using the trained denoise transformer 250 to generate a second set of unmasked motion tokens, and transform the first set of unmasked motion tokens and the second set of unmasked motion tokens into a skeletal representation of human motion using the trained VQ-VAE model 240.

According to one aspect, the processor 210 may perform joint sampling where the denoise transformer 250 iteratively unmasks the motion tokens for the first set of motion tokens and the second set of motion tokens concurrently. Explained another way, during joint sampling, multiple motions or actions from the action sentence may be considered simultaneously or concurrently, such as by concatenating action tokens from successive actions for conditioning. In this way, a compound condition that infuses the motion generation with contextual information may be provided, thereby ensuring the resulting sequence is both cohesive and reflective of intended actions. The joint sampling performed may effectively sketch a coarse outline of multi-motion sequences.

According to one aspect, the processor 210 may perform independent sampling where the denoise transformer 250 iteratively unmasks the motion tokens for the first set of motion tokens independent of the second set of motion tokens. Explained another way, during independent sampling, merely single motions or single actions from the action sentence may be considered at one time during the processing by the processor 210. The independent sampling performed may represent a refinement for a single motion of the multi-motion sequence.

Explained another way, during the denoising phase of the discrete diffusion model, TPS includes sketching the basic contours of each action, and subsequently refining them to capture detailed movements. TPS initiates with joint sampling, in which these initially denoised actions are combined and denoised together, guaranteeing seamless transitions and overall coherence in the sequence. This joint denoising phase updates the motion tokens while considering the influences of neighboring actions. The number of joint denoising steps, denoted by Ts, may be adjusted to achieve smooth transitions without losing the distinctiveness of each action. Joint sampling is then succeeded by independent sampling, where each action is individually denoised to align precisely with its specific description.

In this way, the processor 210 may implement TPS (e.g., the independent sampling and the joint sampling) to transform the first set of unmasked motion tokens and the second set of unmasked motion tokens into the skeletal representation of human motion using the trained VQ-VAE model 240 based on the independent sampling and the joint sampling.

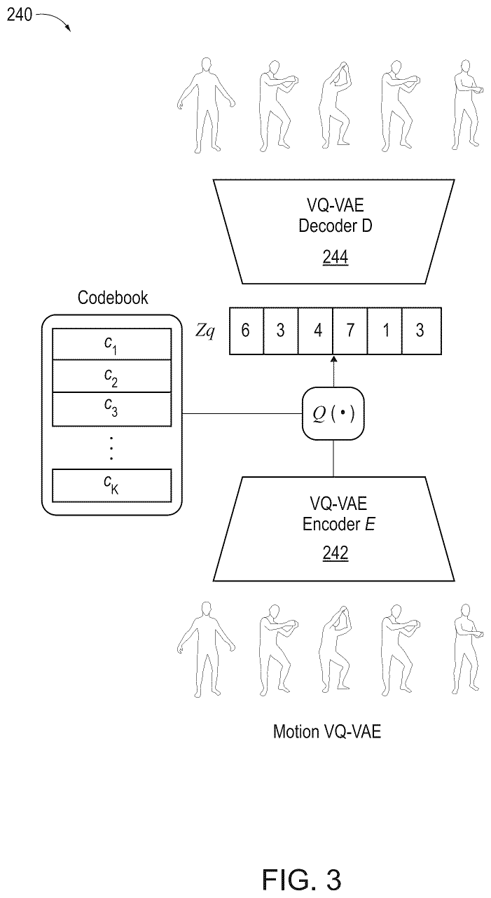

FIG. 3 is an exemplary vector quantized variational autoencoder (VQ-VAE) in association with the system 200 for multi-motion generation, according to one aspect. In FIG. 3, it may be seen that the VQ-VAE is trained to obtain one or more motion tokens.

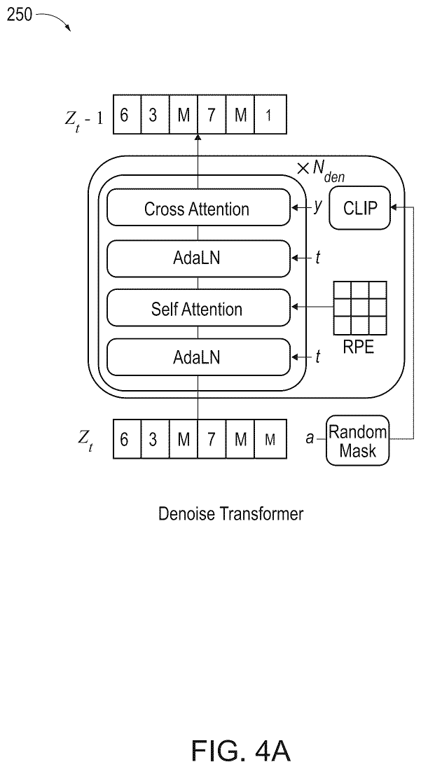

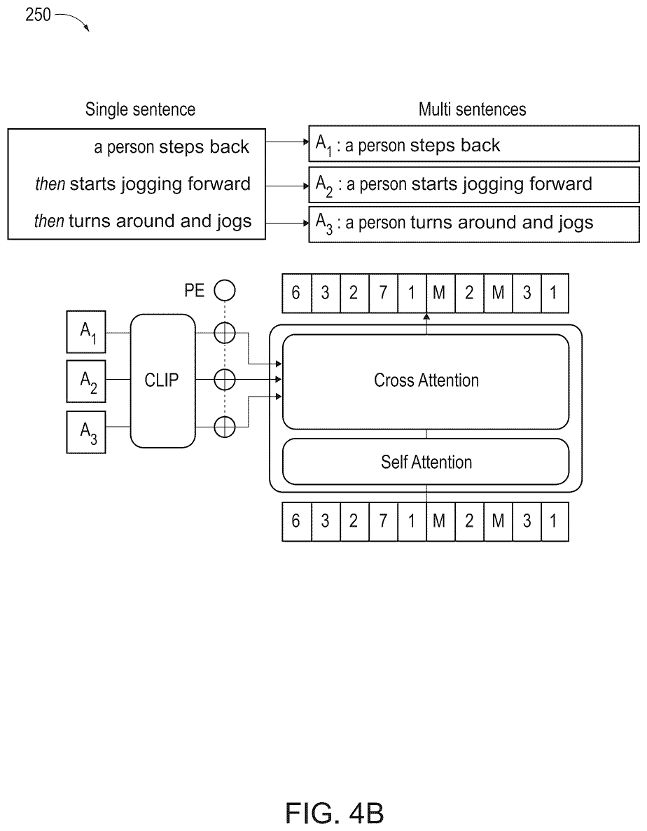

FIG. 4A is an exemplary denoise transformer 250 in association with the system 200 for multi-motion generation, according to one aspect. Respective motion tokens from FIG. 3 may be utilized to train the denoise transformer 250 for a discrete diffusion model. As seen from FIGS. 4-6, an ‘M’ denotes a masked token or a masked frame.

FIG. 4B is an exemplary multi-motion discrete diffusion model in association with the system 200 for multi-motion generation, according to one aspect. In FIG. 4B, action sentence conditioning of the model may be seen. Sentences may be initially decomposed by the processor 210 to extract action verbs. The processor 210 may subsequently utilize these verbs to construct new sentences. These newly formed sentences may then serve as conditions for generating human motion sequences.

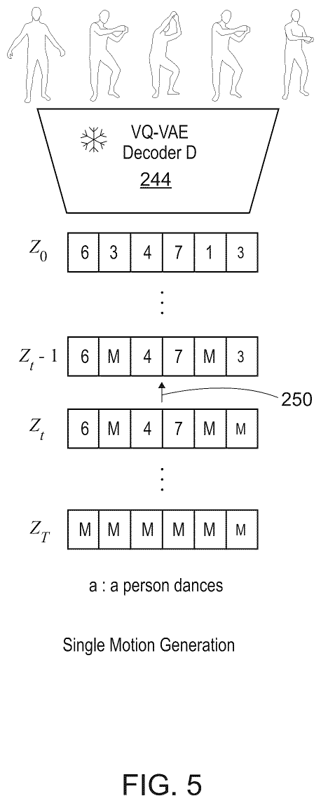

FIG. 5 is an exemplary vector quantized variational autoencoder (VQ-VAE) decoder 244 in association with the system 200 for multi-motion generation, according to one aspect. In FIG. 5, the denoise transformer 250 and the VQ-VAE may be utilized to perform single motion generation by the processor 210.

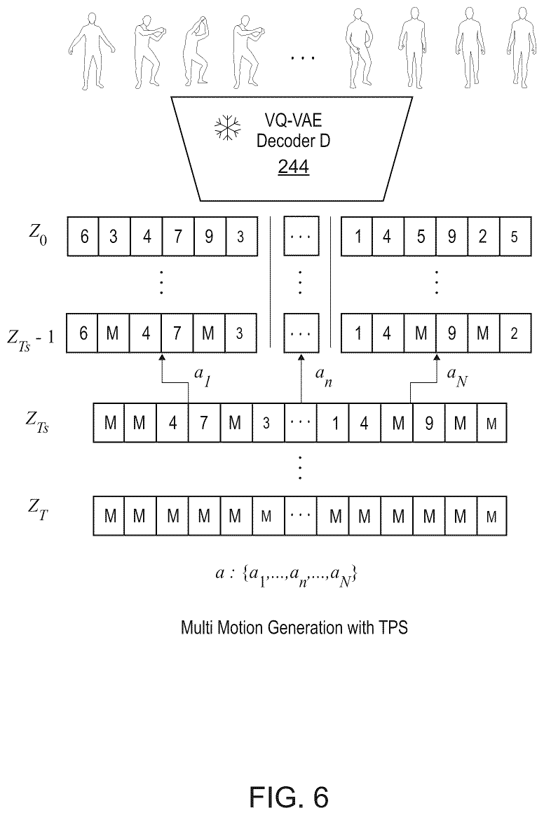

FIG. 6 is an exemplary vector quantized variational autoencoder (VQ-VAE) decoder 244 with two-phase sampling (TPS) in association with the system 200 for multi-motion generation, according to one aspect. In FIG. 5, the denoise transformer 250 and the VQ-VAE may be utilized to perform TPS motion generation by the processor 210.

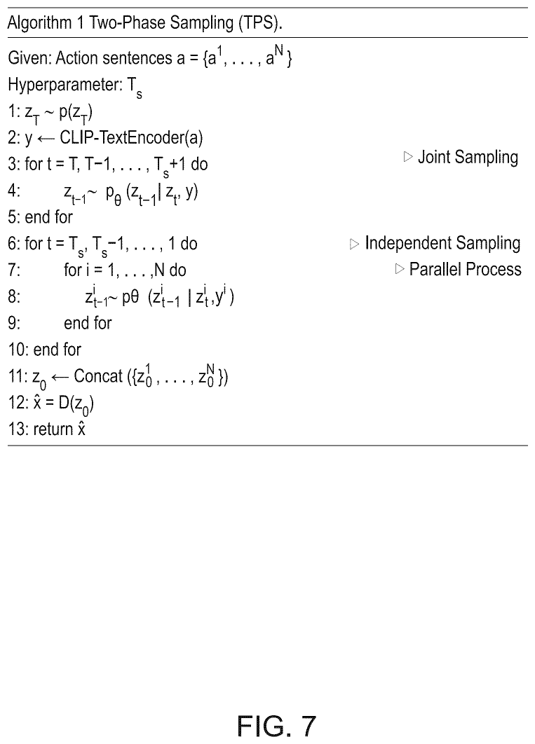

FIG. 7 is an exemplary algorithm in association with the system 200 for multi-motion generation, according to one aspect. As seen in FIG. 7, an overview of TPS is provided. In the algorithm of FIG. 7, the subscripts represent diffusion steps, while superscripts denote action indices. TPS effectively overcomes the challenge of ensuring smooth transitions between distinct actions, while preserving the distinctiveness of each motion segment as per its action description.

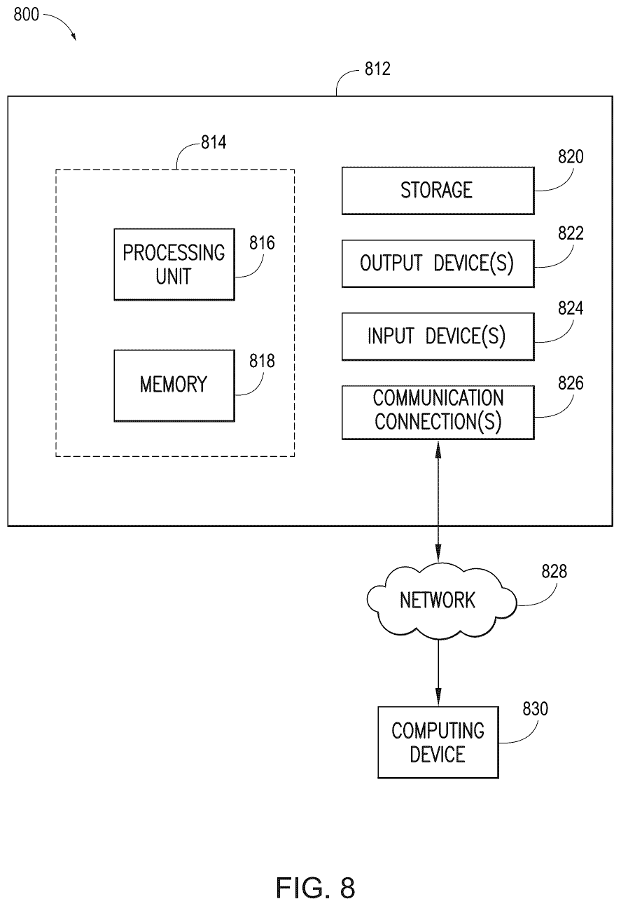

FIG. 8 and the following discussion provide a description of a suitable computing environment to implement aspects of one or more of the provisions set forth herein. The operating environment of FIG. 8 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 8 illustrates a system 800 including a computing device 812 configured to implement one aspect provided herein. In one configuration, the computing device 812 includes at least one processing unit 816 and memory 818. Depending on the exact configuration and type of computing device, memory 818 may be volatile, such as RAM, non-volatile, such as ROM, flash memory, etc., or a combination of the two. This configuration is illustrated in FIG. 8 by dashed line 814.

In other aspects, the computing device 812 includes additional features or functionality. For example, the computing device 812 may include additional storage such as removable storage or non-removable storage, including, but not limited to, magnetic storage, optical storage, etc. Such additional storage is illustrated in FIG. 8 by storage 820. In one aspect, computer readable instructions to implement one aspect provided herein are in storage 820. Storage 820 may store other computer readable instructions to implement an operating system, an application program, etc. Computer readable instructions may be loaded in memory 818 for execution by the at least one processing unit 816, for example.

The term “computer readable media” as used herein includes computer storage media. Computer storage media includes volatile and nonvolatile, removable, and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 812. Any such computer storage media is part of the computing device 812.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 812 includes input device(s) 824 such as keyboard, mouse, pen, voice input device, touch input device, infrared cameras, video input devices, or any other input device. Output device(s) 822 such as one or more displays, speakers, printers, or any other output device may be included with the computing device 812. Input device(s) 824 and output device(s) 822 may be connected to the computing device 812 via a wired connection, wireless connection, or any combination thereof. In one aspect, an input device or an output device from another computing device may be used as input device(s) 824 or output device(s) 822 for the computing device 812. The computing device 812 may include communication connection(s) 826 to facilitate communications with one or more other devices 830, such as through network 828, for example.

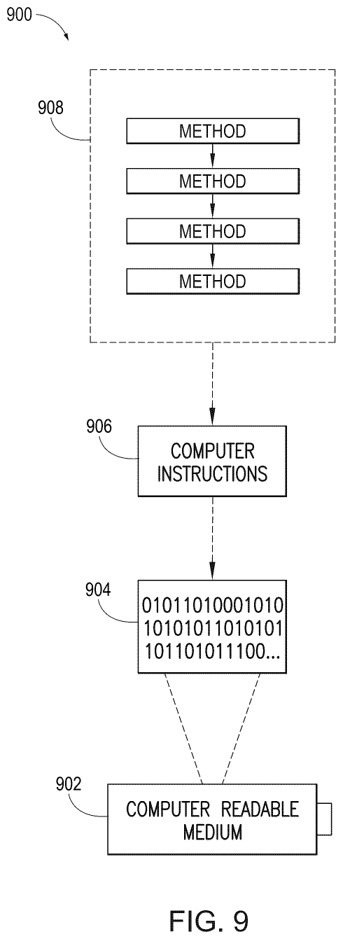

Still another aspect involves a computer-readable medium including processor-executable instructions configured to implement one aspect of the techniques presented herein. An aspect of a computer-readable medium or a computer-readable device devised in these ways is illustrated in FIG. 9, where an implementation 900 includes a computer-readable medium 902, such as a CD-R, DVD-R, flash drive, a platter of a hard disk drive, etc., on which is encoded computer-readable data 904. This encoded computer-readable data 904, such as binary data including a plurality of zero's and one's as shown in 904, in turn includes a set of processor-executable computer instructions 906 configured to operate according to one or more of the principles set forth herein. In this implementation 900, the processor-executable computer instructions 906 may be configured to perform a method 908, such as the computer-implemented method 100 of FIG. 1. In another aspect, the processor-executable computer instructions 906 may be configured to implement a system, such as the system 200 for multi-motion generation of FIG. 2. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A computer-implemented method for multi-motion generation, comprising:
training a variational autoencoder (VAE) model based on a skeletal representation of human motion, one or more motion tokens associated with the skeletal representation of the human motion, and a dynamic transition probability based on a distance between the one or more motion tokens; and
training a denoise transformer by performing self-attention based on the one or more motion tokens and cross-attention based on the one or more motion tokens and an action sentence.

2. The computer-implemented method for multi-motion generation of claim 1, wherein the VAE model is a vector quantized variational autoencoder (VQ-VAE) model.

3. The computer-implemented method for multi-motion generation of claim 1, wherein the VAE model converts the skeletal representation of the human motion into one or more motion tokens and reconstructs the human motion from the one or more motion tokens.

4. The computer-implemented method for multi-motion generation of claim 1, wherein the training the denoise transformer by performing the self-attention is based on relative positional encoding (RPE).

5. The computer-implemented method for multi-motion generation of claim 1, comprising:
receiving a runtime action sentence;
converting the runtime action sentence into a set of runtime motion tokens;
iteratively unmasking runtime motion tokens of the set of runtime motion tokens using the trained denoise transformer; and
transforming the unmasked runtime motion tokens into a runtime skeletal representation of the human motion using the trained VAE model.

6. The computer-implemented method for multi-motion generation of claim 1, comprising:
receiving a runtime action sentence including a first action and a second action;
converting the runtime action sentence into a first set of runtime motion tokens corresponding to the first action and a second set of runtime motion tokens corresponding to the second action;
iteratively unmasking runtime motion tokens of the first set of runtime motion tokens using the trained denoise transformer to generate a first set of unmasked runtime motion tokens;
iteratively unmasking runtime motion tokens of the second set of runtime motion tokens using the trained denoise transformer to generate a second set of unmasked runtime motion tokens; and
transforming the first set of unmasked runtime motion tokens and the second set of unmasked runtime motion tokens into a runtime skeletal representation of the human motion using the trained VAE model.

7. The computer-implemented method for multi-motion generation of claim 6, comprising performing independent sampling wherein the denoise transformer iteratively unmasks the runtime motion tokens for the first set of runtime motion tokens independent of the second set of runtime motion tokens.

8. The computer-implemented method for multi-motion generation of claim 6, comprising performing joint sampling wherein the denoise transformer iteratively unmasks the runtime motion tokens for the first set of runtime motion tokens and the second set of runtime motion tokens concurrently.

9. The computer-implemented method for multi-motion generation of claim 6, wherein training the denoise transformer includes performing normalization on the one or more motion tokens.

10. The computer-implemented method for multi-motion generation of claim 6, wherein the training the denoise transformer includes performing the cross-attention based an action token derived from the action sentence.

11. A system for multi-motion generation, comprising:
a memory storing one or more instructions;
a processor executing one or more of the instructions stored on the memory to perform:
receiving a runtime action sentence;
converting the runtime action sentence into a set of runtime motion tokens;
iteratively unmasking runtime motion tokens of the set of runtime motion tokens using a trained denoise transformer; and
transforming the unmasked runtime motion tokens into a runtime skeletal representation of the human motion using a trained variational autoencoder (VAE) model,
wherein the trained VAE model is trained based on a skeletal representation of human motion, one or more motion tokens associated with the skeletal representation of the human motion, and a dynamic transition probability based on a distance between the one or more motion tokens, and
wherein the trained denoise transformer is trained by performing self-attention based on the one or more motion tokens and cross-attention based on the one or more motion tokens and an action sentence.

12. The system for multi-motion generation of claim 11, wherein the VAE model is a vector quantized variational autoencoder (VQ-VAE) model.

13. The system for multi-motion generation of claim 11, wherein the VAE model converts the skeletal representation of the human motion into one or more motion tokens and reconstructs the human motion from the one or more motion tokens.

14. The system for multi-motion generation of claim 11, wherein the training the denoise transformer by performing the self-attention is based on relative positional encoding (RPE).

15. The system for multi-motion generation of claim 11, wherein the processor performs:
independent sampling wherein the trained denoise transformer iteratively unmasks runtime motion tokens for a first set of runtime motion tokens associated with a first action independent of a second set of runtime motion tokens associated with a second action;
joint sampling wherein the trained denoise transformer iteratively unmasks the runtime motion tokens for the first set of runtime motion tokens and the second set of runtime motion tokens concurrently; and
transforming the first set of unmasked runtime motion tokens and the second set of unmasked runtime motion tokens into a runtime skeletal representation of the human motion using the trained VAE model based on the independent sampling and the joint sampling.

16. A system for multi-motion generation, comprising:
a memory storing one or more instructions;
a processor executing one or more of the instructions stored on the memory to perform:
receiving a runtime action sentence;
converting the runtime action sentence into a set of runtime motion tokens;
iteratively unmasking runtime motion tokens of the set of runtime motion tokens using a trained denoise transformer; and
transforming the unmasked runtime motion tokens into a runtime skeletal representation of the human motion using a trained vector quantized variational autoencoder (VQ-VAE) model,
wherein the trained VQ-VAE model is trained based on a skeletal representation of human motion, one or more motion tokens associated with the skeletal representation of the human motion, and a dynamic transition probability based on a distance between the one or more motion tokens, and
wherein the trained denoise transformer is trained by performing self-attention based on the one or more motion tokens and cross-attention based on the one or more motion tokens and an action sentence.

17. The system for multi-motion generation of claim 16, wherein the training the denoise transformer by performing the self-attention is based on relative positional encoding (RPE).

18. The system for multi-motion generation of claim 16, comprising:
receiving a runtime action sentence;
converting the runtime action sentence into a set of runtime motion tokens;
iteratively unmasking runtime motion tokens of the set of runtime motion tokens using the trained denoise transformer; and
transforming the unmasked runtime motion tokens into a runtime skeletal representation of the human motion using the trained VQ-VAE model.

19. The system for multi-motion generation of claim 16, comprising:
receiving a runtime action sentence including a first action and a second action;
converting the runtime action sentence into a first set of runtime motion tokens corresponding to the first action and a second set of runtime motion tokens corresponding to the second action;
iteratively unmasking runtime motion tokens of the first set of runtime motion tokens using the trained denoise transformer to generate a first set of unmasked runtime motion tokens;
iteratively unmasking runtime motion tokens of the second set of runtime motion tokens using the trained denoise transformer to generate a second set of unmasked runtime motion tokens; and
transforming the first set of unmasked runtime motion tokens and the second set of unmasked runtime motion tokens into a runtime skeletal representation of the human motion using the trained VAE model.

20. The system for multi-motion generation of claim 19, comprising:
performing independent sampling wherein the denoise transformer iteratively unmasks the runtime motion tokens for the first set of runtime motion tokens independent of the second set of runtime motion tokens; and
performing joint sampling wherein the denoise transformer iteratively unmasks the runtime motion tokens for the first set of runtime motion tokens and the second set of runtime motion tokens concurrently.
